(19) United States
(12) Patent Application Publication
(10) Pub. No.: US 2012/0329012 A1
(43) Pub. Date: Dec. 27, 2012

(54) Labeling System and Method to Improve Food Selection within a Retail Environment

(76) Inventor: Twila M. Remund, Watertown, MN (US)

(21) Appl. No.: 13/523,047

(22) Filed: Jun. 14, 2012

Related U.S. Application Data
(60) Provisional application No. 61/501,621, filed on Jun. 27, 2011.

(51) Int. Cl. G09B 19/00

(52) U.S. Cl. 434/127

(57) ABSTRACT

A method and system for conducting a weight loss program. The program includes a program center working in co-operation with a food store to include a distinct program label adjacent to the standard label for appropriate foods designated within the program. The program center includes a data collection area to collect a user's physical measurements and questionnaire answers. These measurements and answers will result in a unique diet plan for each user and designate the appropriate serving amounts for a given category of foods. The user will then use the distinct program label to local the allowable foods and purchase them. Preferably, the program center is located within or adjacent to a grocery store.

### CROSS REFERENCE TO RELATED APPLICATIONS

This application claims priority to application No. 61/501,621 titled Food Centers Attached and or Within Grocery Stores filed on Jun. 27, 2011 to the above named inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a method and system to improve the process of selecting for purchase within a retail environment the proper foods and food groups for targeted weight loss by utilizing a distinct label identifier for qualifying foods.

It is well known that the current US population is facing an obesity epidemic. As the population continues to grow, so does the weight of individuals. The two major causes of weight gain are diet and lack of exercise. Currently, there are several strategies and programs used by individuals to control their diet. Two common programs are the purchase of prepackaged meals and the assigning of points for a given food and tracking the number of points consumed. Although both of these programs can be beneficial, they do have drawbacks. The programs and meals are often expensive and require monthly fees. Further, it is difficult for users to continue the regimented programs for extended periods of time, often resulting in weight gain after the conclusion of the program.

Consumers, although enjoying some of the benefits the programs offer, are looking for alternatives. They would like a new program that is easy, cost effective, and amenable to their normal daily lifestyle. Ideally, this new program utilizes the consumers existing grocery store or supermarket and is based upon education and proper food choice decision making within the shopping environment. Preferably, this system uses labels to clearly identify allowable foods and allow the consumer to easily select the proper item corresponding to a predetermined meal plan.

### SUMMARY OF THE INVENTION

The present invention provides a system and method for selecting the proper foods within a retail environment for purchase for targeted weight loss. The system and method is individually customized for each user based upon their individual dietary needs and allows them to easily select for purchase the proper items and ingredients to meet their individual weight loss or weight maintenance goals. The system and method utilizes a unique labeling system to categorize individual foods and ingredients that is displayed on the shelf next to the standard label, whereby this label clearly identifies the item as an acceptable food within the individual's predetermined plan.

According to this system and method, hereinafter designated as the program, a user will enter a designated program center hosting the program. Preferably, this program center is located within or adjacent to a grocery store, although this is not necessary for the success of the program. This program center will include an individual to greet the user and discuss the program and the details. This program center may include a computer terminal with access to the internet and a server containing data storage elements, a scale, and private area allowing the user to have a series of measurements taken in privacy.

After entering the program center the user will be asked a series of screening questions to determine their dietary, weight loss, or weight maintenance goals. After the initial screening, the user will be measured to create a baseline to determine the dietary changes required and to measure progress. The measurements taken may include the user's weight, height, body mass index (BMI), percentage of body fat, circumference of certain body areas including, but not limited to, the waist, bust, hips, thighs, and arms.

The measurements and questions will then be entered into the computer terminal and stored on a central database. Preferably this database is stored on an external server accessible through the internet to allow users to track and monitor progress and provide data to several locations. The measurement data and the screening questions are combined to create a unique diet plan for the user. This diet plan will be printed out for the user to reference during shopping.

The diet plan will include the user's basic information, along with nutritional tips, such as proper water intake, portion size, and foods to avoid, etc. Additionally, this diet plan will include the number of servings of each of the main categories of food the user should eat per day. These categories are: proteins excluding nuts, vegetables, grains, fruits, dairy, and snacks. Each of these categories is assigned an identifying characteristic to differentiate it from another category, such as a unique color, picture, letter, or number. Preferably, each category is assigned a unique color such as proteins colored red, vegetables colored green, grains colored yellow, fruits colored orange, dairy colored blue, and snacks colored brown.

This diet plan will then be used during the user's shopping to ensure that the user purchases food in the proper serving amount from the designated category of the diet plan. This step requires the combined co-operation of the program and the retail store to properly label the appropriate foods and ingredients allowable within the program. This co-operation will allow the user to quickly find and purchase the acceptable foods within the program.

Preferably, the diet plan will include within the print-out of the plan a picture of a plate composed of the appropriate colored categories of food divided and organized into the proper number of servings the user is scheduled to consume within a day. In use, the user will take the plate graphic with them throughout the store and find a label corresponding to the type of food required for the user's diet plan. The user will then purchase the appropriate of foods in the proper quantities.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 shows a schematic of the overall system and method, according to the present invention;

FIG. 2 is a table of the food groups within the system and method, according to the present invention; and

FIG. 3 is a view of a print out of the plate of options, according to the present invention.

### DETAILED DESCRIPTION OF THE INVENTION

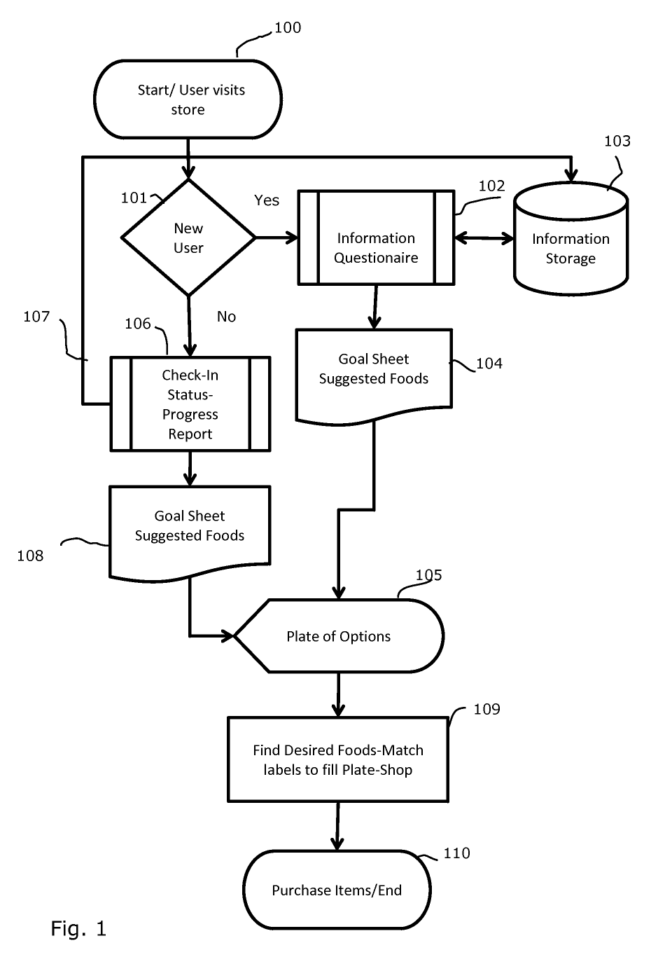

Referring now to FIG. 1, a schematic of the overall system and method of a weight loss program according to the present invention, there is shown the start 100. At the start of the process a user enters a program center 100 offering the program. Preferably, the program center is located within or adjacent to a grocery store, although this is not necessary for the success of the program. The convenience of having the program center within a grocery store provides a benefit to the program center and the grocery store as well as the user. A determination will be made if the user is a new user or an existing user 101. If the user is a new user they will complete an initial screening 102.

This initial screening 102 will consist of a series of screening questions to determine the user's dietary, weight loss, or weight maintenance goals and collect a series of baseline measurements. The measurements taken may include the user's weight, height, body mass index (BMI), percentage of body fat, circumference of certain body areas including, but not limited to, the waist, bust, hips, thighs, and arms. The measurements taken and question answers received during the screening process 102 are entered into a computer terminal and stored in a database 103 for future use. Preferably this database 103 is stored on an external server accessible through the internet to allow users to track and monitor progress and provide database access at several locations.

After entry into the stored database 103, the information gained during the screening process 102 is used to create a diet plan for each individual user. This diet plan will consist of a goal sheet with suggested best nutritional practices for the user 104 and display a graphic of a plate, designated as a plate of options, as shown in FIG. 3, with the designated number of servings for a given category of food 105 the user should purchase according to the diet plan.

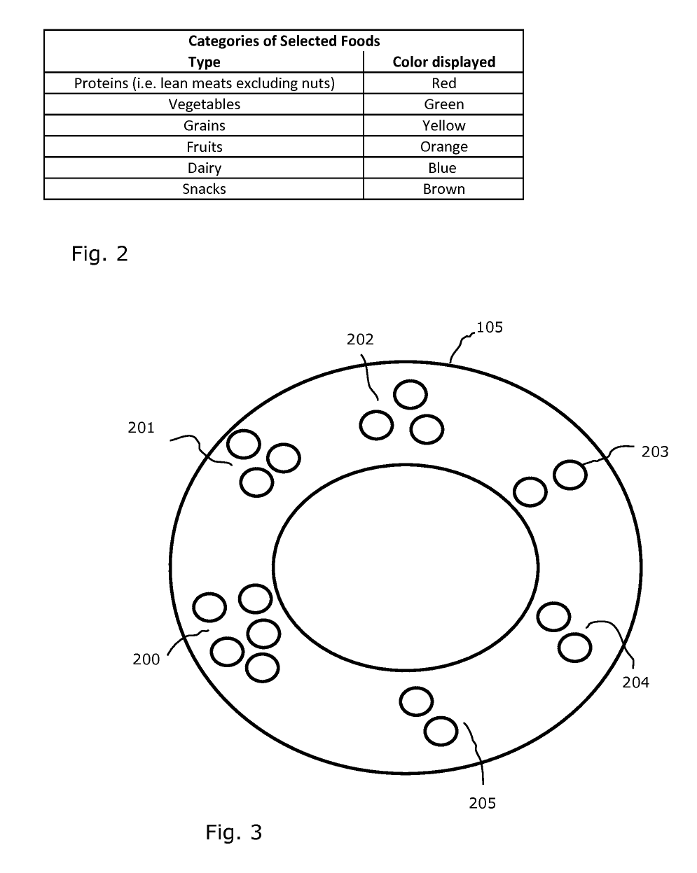

The diet plan will include the user's basic information, along with nutritional tips, such as proper water intake, portion size, and foods to avoid, etc. Additionally, this diet plan will include the number of servings of each of the main categories of food the user should eat per day. These categories, as shown in FIG. 2, are: proteins excluding nuts, vegetables, grains, fruits, dairy, and snacks. Each of these categories is assigned an identifying characteristic to differentiate it from another category, such as a unique color, picture, letter, or number. Preferably, each category is assigned a unique color, as shown in FIG. 2, such as proteins colored red, vegetables colored green, grains colored yellow, fruits colored orange, dairy colored blue, and snacks colored brown.

This diet plan will then be used during the user's shopping 109 to ensure that the user purchases food 110 in the proper serving from the designated category of the diet plan. This step requires the combined co-operation of the program and the retail store to properly label the appropriate foods and ingredients allowable within the program. Preferably, the program and the store will work together to identify the foods and ingredients allowable in a variety of plans and label these foods and ingredients accordingly. Preferably, a separate and distinct label will be located adjacent to the standard label as seen in the store and carry the category identifier designated by the plan.

Preferably, this separate and distinct label is a colored design located adjacent to the standard label and easily located and identified. According to this process, during shopping a user, after receiving the diet plan with the plate of options 105, will only select items allowable with the plan by utilizing the distinct label as shown adjacent to the standard label.

Preferably, a color, as shown in FIG. 2, will be used to identify a category of food. A label designating the selected color will be placed adjacent to the standard label for each of the foods or ingredients allowable within the program and displayed on the user's plate of options 105 graphic, FIG. 3. A user will then use the plate of options 105 graphic, FIG. 3, to select the items to purchase. For example, if the user's plate of options 105 graphic display's three red designs, three orange designs, two yellow designs, two blue designs, two brown designs, and five green designs corresponding to the number of servings of each category allowable within a given day, a user will use the distinct label displayed with the appropriate category color to purchase the proper amount of food.

Accordingly, if a user is using the above plate of options 105 for shopping they would approach the meat or deli section of the grocery store to purchase their allotted servings of protein as designated by the plate of options 105. As protein is designated red, a user will look for a red label for allowable foods within the plan and purchase only the items with a designated label. This same process will be used for each corresponding category. Additionally, the label may display the number of servings of each category contained within a given package. For example, if a user is looking to select their allowable protein as designated on the plate of options 105, they may select a package of chicken breasts designated with a red label; this label may contain an indicator identifying the number of servings of protein allowable within the plan contained within this package of chicken breasts. This indicator may be a number or the label may be repeated multiple times to indicate the proper number of servings within the package.

A user already entered into the program 106 will go through a similar process as a new user 102 with a few changes. A current user of the program 106 will go through a status update and check-in process 106. During this check-in process 106 a user may be re-measured or answer additional questions based upon their progress and goals. The information collected 107 will be stored in the same database 103 as when the user first registered for the program. Similar to the new user, the existing user will be presented with a print-out 108 containing the diet plan and the plate of options 105. The process of shopping is the same as the new user.

Referring now to FIG. 2, a table displaying the categories of foods along with an assigned color to be used on the plate of options 105 and distinct program label. The categories of foods or ingredients including within the program are proteins (excluding nuts), vegetables, grains, fruits, dairy, and snacks. Each of these categories is assigned a unique color to identify the category for use on the distinct program label and the plate of options 105. According to this table, the color red is identified with protein, the color green is identified with vegetables, the color yellow is identified with grains, the color orange is identified with fruits, the color blue is identified with dairy, and the color brown is identified with snacks. Although colors are the preferred identifier, due to ease of use other identifying characteristics may be used, such as designs, logos, numbers, letters, or other simple identification mechanism. Likewise, although these are the preferred colors to represent a given category other colors may be used.

Referring now to FIG. 3, a view of the print out of the plate of options 109 according to the present invention, there is shown an allotment of the given categories of foods and serving amounts available to a given individual within a unique plan. According to this plate of options 109, the user is allotted five servings of vegetables 200, three servings of fruits 201, three servings of proteins 202, two servings of grains 203, two servings of dairy 204, and two servings of snacks 205. With this displayed plate of options 105 the user would shop for the indicated servings of each category by locating the appropriate distinct program label within the store and making their purchase.

What is claimed is:

1. A weight loss program and method comprising:
a user;
a program center, the program center having a data collection area, the data collection area being used to collect the user's data including the user's physical measurements and answers to a predetermined questionnaire;
a diet plan, the diet plan created from the user's data and including a plate of options, the plate of options displaying the number of servings of a given category of foods, the category of foods comprising proteins, grains, vegetables, fruits, dairy, and snacks using a unique identifier for each category; and
a distinct program label, the distinct program label corresponding to the unique identifier and placed adjacent to a standard label located within a food store.

2. A weight loss system and method according to claim 1, wherein the unique identifier is a color.

3. A weight loss system and method according to claim 1, wherein the program center is located within a grocery store.

4. A weight loss system and method according to claim 1, wherein the program center is located adjacent to a grocery store.
